(19) United States
(12) Patent Application Publication
(10) Pub. No.: US 2009/0142577 A1
(43) Pub. Date: Jun. 4, 2009

(54) COMPOSITE WEBS AND METHODS OF MANUFACTURING THE SAME

(76) Inventors: Randall L. Alberg, Maplewood, MN (US); Dennis L. Becker, Vadnais Heights, MN (US); Byron M. Jackson, Forest Lake, MN (US); Daniel S. McDonald, Hudson, WI (US); Leigh E. Wood, Woodbury, MN (US)

Correspondence Address: 3M INNOVATIVE PROPERTIES COMPANY, PO BOX 33427, ST. PAUL, MN, 55133-3427, US

(21) Appl. No.: 12/364,824

(22) Filed: Feb. 3, 2009

Related U.S. Application Data
(62) Division of application No. 12/235,656, filed on Sep. 23, 2008.
Application No. 12/235,656 is a division of application No. 11/531,825, filed on Sep. 14, 2006.

(51) Int. Cl. B32B 7/12

(52) U.S. Cl. 428/317.1

(57) ABSTRACT

Composite webs having a structured web attached to a carrier web and methods of manufacturing the composite webs are disclosed. The structured web may include a plurality of structures that protrude from the structured web. The methods may involve delivering a molten polymeric composition onto the outer surface of a forming tool that includes a plurality of depressions formed in the outer surface. The molten polymer enters depressions in the outer surface of the forming tool and is solidified therein such that a plurality of structures are formed in the shape of the depressions. A skin layer of the polymeric composition may extend between the depressions, such that the structured web formed on the forming tool includes a skin layer connecting the structures. The structured web is removed from the forming tool after solidification of the polymeric composition by adhering the structured web to a carrier web using adhesive located between the carrier web and structured web.

### CROSS REFERENCE TO RELATED APPLICATIONS

This is a divisional application of pending prior application U.S. Ser. No. 12/235,656, filed Sep. 23, 2008; which is a divisional of application U.S. Ser. No. 11/531,825, filed Sep. 14, 2006, the disclosures of which are incorporated by reference in their entirety herein.

### TECHNICAL FIELD

The present invention relates to composite webs and methods of manufacturing the composite webs. The composite webs include a carrier web with a structured web that includes a plurality of polymeric structures attached to at least one major surface of the carrier web.

### BACKGROUND OF THE INVENTION

The manufacture of composite webs that require the attachment of reinforcing and/or elastic components to an underlying substrate is the subject of many different approaches. Although reinforcement may be provided over the entire substrate, such approaches can add unnecessary cost and/or weight to the composite web. Such constructions may also increase stiffness over the entire surface of the composite web.

While a variety of approaches to providing discrete polymeric structures on substrates are disclosed in, e.g., U.S. Patent Application Publication No. US 2003/0085485 A1, filed 5 Nov. 2001 and titled SYSTEMS AND METHODS FOR COMPOSITE WEBS WITH STRUCTURED DISCRETE POLYMERIC REGIONS; U.S. Patent Application Publication No. US 2003/0087098 A1, filed 5 Nov. 2001 and titled COMPOSITE WEBS WITH REINFORCING POLYMERIC REGIONS AND ELASTIC POLYMERIC REGIONS; U.S. Patent Application Publication No. US 2003/0084996 A1, filed 5 Nov. 2001 and titled METHODS FOR PRODUCING COMPOSITE WEBS WITH REINFORCING DISCRETE POLYMERIC REGIONS; U.S. Patent Application Publication No. US 2003/0087059 A1, filed 5 Nov. 2001 and titled COMPOSITE WEBS WITH DISCRETE ELASTIC POLYMERIC REGIONS; U.S. Patent Application Publication No. US 2004/0178544 A1, filed Mar. 13, 2003 and titled POLYMER TRANSFER APPARATUS, METHODS, AND COMPOSITE WEBS; and U.S. Patent Application Publication No. US 2004/0180186, filed Dec. 22, 2003 and titled COMPOSITE WEBS AND CLOSURE SYSTEMS; these approaches may be limited in certain aspects, such as in roll temperatures, the composition of substrates, etc.

### SUMMARY OF THE INVENTION

The present invention provides composite webs having a structured web attached to a carrier web and methods of manufacturing the composite webs. The structured web preferably includes a plurality of structures that protrude from the structured web.

The methods may preferably involve delivering a molten polymeric composition onto the outer surface of a forming tool that includes a plurality of depressions formed in the outer surface. The molten polymer enters depressions in the outer surface of the forming tool and is solidified therein such that a plurality of structures is formed in the shape of the depressions. A skin layer of the polymeric composition preferably extends between the depressions, such that the structured web formed on the forming tool includes a skin layer connecting the structures. The structured web is removed from the forming tool after solidification of the polymeric composition by adhering the structured web to a carrier web using adhesive located between the carrier web and structured web.

It may be preferred that the skin layer interconnecting the plurality of structures of the structured web is relatively thin relative to the thickness of the structures themselves. As a result, the skin layer may be particularly fragile. It may be preferred in methods of the present invention that the structured web be held in a relaxed state during its formation and during its removal from the outer surface of the forming tool. By “relaxed” as used herein, it is meant that the structured web is not under tension (other than the internal stresses that may result in an object as a result of hardening from a molten state).

In some embodiments, the structured webs of composite webs of the present invention may be included to provide elasticity to the composite web where, for example, the carrier web (and coverweb, if any) do not exhibit elastic properties or do not do so sufficiently. In such composite webs, the structures in the structured web may preferably exhibit elasticity when attached to the carrier web, such that the composite web as a whole exhibits elasticity. As used herein, the term “elasticity” (and variations thereof) means that the article in question (e.g., a composite web or a structure in a structured web) will substantially resume a significant portion of its original shape after being stretched. It may be preferred that the recovery of an elastic portion of a composite web be at least 20% of the elongation experienced as a result of moderate stretching (e.g., undergoing a maximum elongation of about 150% of original length).

The structured webs of composite webs of the present invention may preferably be formed using thermoplastic polymeric compositions. As used in connection with the present invention, “thermoplastic” (and variations thereof) means a polymer or polymeric composition that softens when exposed to heat and returns to its original condition or near its original condition when cooled to room temperature. The polymeric compositions used in connection with the methods of the present invention are preferably capable of flowing or entering into depressions in a forming tool as described herein.

By maintaining the forming tools used to form and transfer the structured webs to carrier webs below the melt processing temperature of the polymeric composition, the molten polymeric composition applied to the forming tool can be solidified (or freeze) before the structured webs formed by the polymeric composition are removed from the forming tool. Because the polymeric composition of the structured web is solidified before being attached to the carrier web, the polymeric composition of the structured web cannot infiltrate a porous surface of the carrier web or encapsulate any fibers of a fibrous carrier web. Nor can the solidified polymeric composition of the structured web intermix with polymers of a non-porous or non-fibrous carrier web.

Solidifying the polymeric composition of the structured web before removing the structured web from the forming tool may reduce concerns regarding the internal cohesive strength of the carrier web and/or the tensile strength of the carrier web if, e.g., the carrier web includes a fibrous construction (e.g., woven, nonwoven, or knit fibers) that could be separated from the remainder of the carrier web by the forces exerted when the structured web is pulled away from the forming tool. The solidification or freezing of the polymeric composition in the structured web before removal may preferably reduce any forces exerted on the carrier web as the structured web is removed from the forming tool.

A potential advantage of the adhesive transfer and attachment processes of the present invention is that the resulting composite web may be more flexible than composite webs in which molten polymer is used to attach structures to a carrier web. The improved flexibility may be provided because the polymer of the structured webs of the present invention does not melt or infiltrate the surface of the carrier web during the attachment process.

In the case of composite webs designed to exhibit elasticity, another potential advantage of the adhesive transfer and attachment methods of the present invention may be found in more uniform elongation or extension of the carrier web. In composite webs in which molten polymer infiltrates the porous surface of the carrier web or encapsulates fibers on the surface of the carrier web, elongation of the underlying porous or fibrous carrier web may be hindered. In contrast, adhesive attachment of structured webs in accordance with the present invention to carrier webs may allow even the portions of the carrier webs that lie underneath the structures of the attached structured webs to elongate when the composite web is stretched.

Another potential advantage of the adhesive transfer and attachment methods of the present invention is that the carrier web may retain its strength after attachment of the structured web. In composite webs that rely on molten polymer infiltrating a porous carrier web or encapsulating fibers of a fibrous carrier web for attachment of structures formed by the molten polymer, the tensile strength of the underlying carrier web may be reduced at the edges of the polymer structures fused to the carrier web.

Still another potential advantage of the methods of the present invention is the ability to attach structures to the carrier web, where the structures have a selected shape that is defined by the depressions in the forming tool used to deliver the structures to the carrier web (as a part of the structured web). Control over the shape of the structures of the structured web may provide improved control over the mechanical properties associated with those structures (e.g., elasticity, strength, size, etc.).

Yet another potential advantage of the methods of the present invention is the ability to provide the structures of the structured web in a selected arrangement on the surface of the carrier web. That selected arrangement is defined by the corresponding arrangement of the depressions on the forming tool and is maintained during removal and attachment of the structures and associated skin layer because the removal is accomplished directly from the forming tool to the carrier web (while the structured web is preferably maintained in a relaxed state).

In one aspect, the present invention provides a method for forming a composite web in a continuous process. The method includes delivering molten polymeric composition onto an outer surface of a forming tool, wherein the molten polymeric composition enters a plurality of depressions formed into the outer surface, and wherein a skin layer of molten polymeric composition extends between the plurality of depressions over the outer surface of the forming tool; forming a structured web on the forming tool by solidifying the molten polymeric composition in the skin layer and within the plurality of discrete depressions on the forming tool, wherein the structured web includes a plurality of structures formed in the shape of the plurality of depressions and a skin layer interconnecting the plurality of structures; and removing the formed structured web from the forming tool while the structured web is in a relaxed state on the forming tool, wherein the removing includes adhering the skin layer and the plurality of structures to a first major surface of a carrier web using adhesive exposed on the first major surface of the carrier web; wherein the carrier web and the structured web adhered thereto form a composite web having an indefinite length.

In another aspect, the present invention provides an elastic composite web that includes an extensible carrier web; a structured web adhesively attached to a first major surface of the carrier web by adhesive located between the first major surface of the carrier web and the structured web, the structured web having a skin layer interconnecting a plurality of structures; wherein the structures of the plurality of structures exhibit elastic behavior; wherein the plurality of structures are in a selected arrangement on the first major surface of the carrier; and wherein the structured web is in a relaxed state on the first major surface of the carrier web.

In another aspect, the present invention provides a composite web that includes a carrier web; a structured web adhesively attached to a first major surface of the carrier web by adhesive located between the first major surface of the carrier web and the structured web, the structured web having a skin layer interconnecting a plurality of structures; wherein the plurality of structures comprise a thickness of 1 millimeter or less and the skin layer comprises a thickness of 50 micrometers or less; wherein the plurality of structures are in a selected arrangement on the first major surface of the carrier; and wherein the structured web is in a relaxed state on the first major surface of the carrier web.

These and other features and advantages of the present invention are described below in connection with various illustrative embodiments of the invention.

### BRIEF DESCRIPTIONS OF THE DRAWINGS

FIG. 1 is a cross-sectional view of one example of a composite web including a structured web adhesively attached to a carrier web.

FIG. 2 is a plan view of one major surface of the composite web of FIG. 1, with the structured web attached thereto.

FIG. 3 is a cross-sectional view of an alternative composite web in which adhesive is located on only a portion of the major surface to which the structured web is attached.

FIG. 4 is a cross-sectional view of another composite web including a coverweb attached thereto, with the structured web located between the carrier web and the coverweb.

FIG. 5 is a diagram of one polymer transfer system that may be used to form and attach a structured web to a carrier web in accordance with the methods of the present invention.

FIG. 6 is an enlarged schematic diagram depicting one relationship between a doctor blade and depressions on a forming roll in the system of FIG. 5.

FIG. 7 depicts a forming tool and molten polymer source in connection with use of multiple polymer compositions.

FIG. 8 is a plan view of one example of a structure in a structured web attached to a carrier web, where the structure includes an opening formed therein.

FIG. 9 is a plan view of a depression in the surface of a forming tool that could be used to form the structure of FIG. 8.

FIG. 10 is a cross-sectional view of the depression of FIG. 9, taken along line 10-10 in FIG. 9.

FIG. 11 depicts an exemplary article in the form of a diaper that may incorporate composite webs according to the present invention.

### DESCRIPTION OF EXEMPLARY EMBODIMENTS OF THE INVENTION

As discussed above, the present invention provides composite webs that include structured webs adhesively attached to the surfaces of carrier webs. The composite webs are preferably formed using methods in which a molten polymeric composition is delivered to the surface of a forming tool where it enters depressions in the forming tool and extends over the outer surface of the forming tool. After solidifying, the polymeric composition forms a structured web including structures connected by a skin layer of the polymeric composition. The structured web is removed from the forming tool and adhered to the major surface of a carrier web in a process in which the structured web preferably remains in a relaxed state during its formation and transfer to the carrier web.

Various exemplary composite webs will now be described to illustrate various embodiments of the composite webs and methods of manufacturing them in accordance with the present invention. These exemplary embodiments should not be considered to limit the present invention, which is to be limited only by the claims that follow.

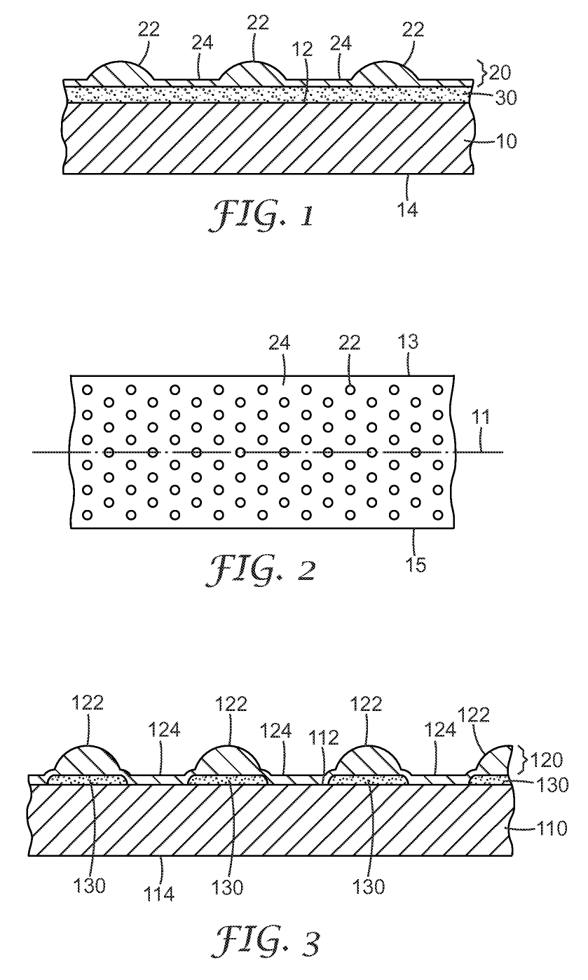

FIG. 1 is a cross-sectional view of a portion of one composite web manufactured in accordance with the present invention. The composite web includes a carrier web 10 with a first major surface 12 and a second major surface 14. Carrier web 10 is preferably in form of a sheet or a film that has two major surfaces with a thickness measured between the major surfaces that is significantly smaller than any dimension measured along the major surfaces.

The webs described herein may be referred to as having an “indefinite length” which, as used herein, means that the length of the web is significantly longer than the width as would occur when using materials stored on rolls and unwound for processing. It may be preferred for example, that webs with an indefinite length have a length that is 100 times or more, preferably 1000 times or more, the width of the web (where width is transverse to length).

The composite web also includes a structured web 20 with a plurality of discrete structures 22 and a skin layer 24 connecting the structures 22. The structured web 20 is adhesively attached to the first major surface 12 of the carrier web 10. It may be preferred that the structures 22 and skin layer 24 of the structured web 20 provide a flat surface facing the major surface 12 of the carrier web 10 to, e.g., enhance contact between the structured web 20 and the carrier web 10. The surface of the structured web 20 that faces away from the major surface 12 of the carrier web 10 may preferably have a shaped profile (i.e., a profile that is not flat) as a result of the structures 22 protruding above the interconnecting skin layer 24.

The structured web 20 may be characterized based on the relative thickness of the structures 22 and the connecting skin layer 24. For example, it may be preferred that the structures 22 in an elastic structured web have a thickness of 250 micrometers (about 0.010 inches) or less. At the lower end of the range, it may be preferred that the structures 22 in an elastic structured web have a thickness of 75 micrometers (about 0.003 inches) or more. If the structures 22 are constructed of nonelastomeric polymers, they may be thicker. For example, it may be preferred that the structures 22 in an inelastic structured web have a thickness of 1 millimeter (about 0.040 inches) or less, in some instances 0.5 millimeter (about 0.020 inches) or less, or even 250 micrometers (about 0.010 inches) or less.

The skin layer 24 connecting the structures 22 in the structured webs of the present invention is thinner than the structures 22. Because the skin layer 24 may not serve any significant structural function in the composite webs of the present invention, it may be preferred that the skin layer 24 be as thin as possible, e.g., it may be preferred that the skin layer 24 have a thickness of 10 micrometers (about 0.0005 inches) or less. In some instances, the skin layer 24 may be as thick as 50 micrometers (about 0.002 inches) or less.

The relative thicknesses of the structures 22 and the skin layer 24 may, in some instances, be characterized as both a ratio and a maximum thickness. For example, it may be preferred that the ratio of the structure thickness to the skin layer thickness be 5:1 or more, or even 10:1 or more. At the same time, it may be preferred that the skin layer 24 have a thickness of 10 micrometers (about 0.0005 inches) or less.

The thickness of both the structures 22 or the skin layer 24 is preferably measured normal to the surface 12 of the carrier web 10 when the carrier web 10 (and its surface 12) are in a flat configuration. In the view depicted in FIG. 1, for example, the thickness of the structures 22 and the skin layer would be measured along lines that run generally vertical on the page. For the structures, the thickness measurements discussed herein are the nominal maximum thicknesses (it being understood that the structures may not have a constant uniform thickness over the are they occupy on the structured web).

As discussed herein, it may be preferred that the thickness of the skin layer 24 be as small as possible. In many instances, the skin layer 24 may be so thin that it can withstand only limited tension if the structured web 20 were removed from the tool on which it is formed (except by the methods of the present invention, namely, contacting the skin layer 24 with an adhesive-bearing carrier web such that the skin layer 24 and the structures 22 it interconnects are removed from the forming tool in a completely relaxed state). In addition, the skin layer 24 may be so thin that it potentially fractures or breaks if the underlying carrier web 10 to which it is adhesively attached is stretched or otherwise put under tension in a web-handling process to, e.g., impart extensibility to the composite web.

Adhesive attachment of structured web 20 to the carrier web 10 is provided by adhesive 30 that is preferably located between the first major surface 12 and the structured web 20. Because the structured web 20 is preferably completely solidified on the forming tool before attachment to the surface 12 of the carrier web 10, the polymeric composition of which the structured web 20 is formed does not infiltrate any portion of the carrier web 10 or encapsulate any fibers located on the surface 12 of the carrier web 10.

Although adhesive 30 is depicted as a layer that is coextensive with the first major surface 12 of the carrier web 10 in FIG. 1, it should be understood that adhesive 30 may not necessarily be coextensive with the first major surface 12 of the carrier web 10. The adhesive or adhesives used in the methods of the present invention can be a single adhesive (as depicted in FIG. 1) or a combination or blend of two or more adhesives. The adhesive or adhesives may be applied to the major surface of the carrier web using any suitable technique, e.g., solvent coating, screen printing, roller printing, melt extrusion coating, melt spraying, stripe coating, laminating processes, etc.

FIG. 2 is a plan view of the first major surface 12 of a portion of the carrier web 10 with the attached structures 22 and skin layer 24 of the structured web. It may be preferred that the carrier web 10 (and the resulting composite web) have an indefinite length along the longitudinal axis 11 and a width between edges 13 and 15 that is measured generally perpendicular to the longitudinal axis 11. Where the composite web is manufactured in a continuous process using a carrier web 10 of indefinite length, the longitudinal axis 11 depicted in FIG. 2 may also coincide with a machine direction for the carrier web 10 (and, therefore, the composite web formed using the carrier web 10).

Although the depicted arrangement of structures 22 of the structured web is in a uniform repeating pattern, the structures 22 may be provided in any selected arrangement within the structured web (and, therefore, on the surface 12 of the carrier web 10). That selected arrangement of the structures 22 will typically be defined by the arrangement of depressions in a forming tool as described herein. Because the structured web is preferably transferred to the carrier web 10 in a relaxed state, the selected arrangement of structures 22 is preferably maintained during attachment of the structured web to the carrier web 10. Transferring the structured web in a relaxed state may also reduce any tendency of the structured web to curl or warp the carrier web.

Also, although the structures 22 of the structured web may all have the same generally circular shape as depicted in FIG. 2, the composite webs of the present invention may include structured webs with structures that have any selected shape, e.g., rectangular, oval, triangular, irregular, etc. In addition, the structures of a structured web attached to the carrier web may all have the same shape within the structured web or a single structured web may include structures with different shapes. Typically, however, the shape or shapes of the structures will be determined by the shapes of the depressions in the forming tool used to manufacture the structured web that is incorporated into the composite web.

FIG. 3 is a cross-sectional view of an alternative embodiment of a composite web according to the present invention in which a structured web 120 is attached to the major surface 112 of carrier web 110. The structured web 120 is attached to the surface 112 by adhesive 130. Unlike the embodiment depicted in FIG. 1, the adhesive 130 is not provided over the entire surface 112 of the carrier web 110. Rather, the adhesive 130 is provided on only a portion of the surface 112 of carrier web 110.

Although the adhesive 130 is depicted as located between the structures 122 of the structured web 120 and the surface 112 of the carrier web 110, the adhesive 130 may alternatively occupy any selected portion of the area between the structured web 120 and the carrier web 110.

The patches of adhesive 130 may be provided on the surface 112 of the carrier web 110 by any suitable technique or techniques, e.g., swirl coating, strip coating (longitudinal or otherwise), etc. The adhesive 130 may, like adhesive 30 described above, be of any suitable composition.

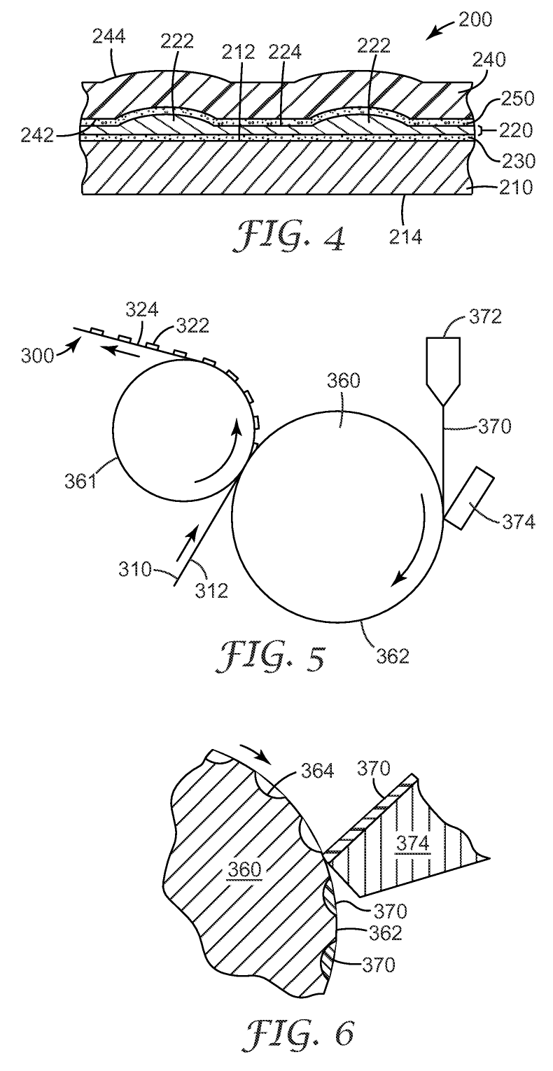

FIG. 4 depicts another composite web 200 in which a coverweb 240 is attached to the composite web 200 with a structured web 220 located between the coverweb 240 and the carrier web 210. The carrier web 210 may preferably include adhesive 230 on its major surface 212 with major surface 214 of the carrier web 210 facing away from the coverweb 240. Adhesive 230 may preferably be used to attach the structured web 220 to the carrier web 210 in much the same manner as described above in connection with the embodiments depicted in FIGS. 1 & 3.

The coverweb 240 may preferably include adhesive 250 on the major surface 242 of coverweb 240 that faces the carrier web 210 (with the coverweb 240 including a major surface 244 facing away from the carrier web 210). The adhesive 250 may preferably be used to attach the coverweb 240 to the composite web 200. The adhesive 250 on the surface 242 of coverweb 240 may attach the coverweb 240 to the structured web 220.

Although both adhesives 230 and 250 are depicted as located over the entire surface 212 of the carrier web 210, portions of the surface 212 of carrier web 210 may be free of adhesive 230 similar to the embodiment depicted in FIG. 3. In addition, adhesive 250 may be provided on only a portion of the surface 242 of the coverweb 240.

FIG. 5 depicts a web path and rolls in one system and method of adhesively attaching a structured web that includes structures 322 and a connecting skin layer 324 to one major surface 312 of a carrier web 310 to form a composite web 300 in accordance with the principles of the present invention. The system depicted in FIG. 5 includes a carrier web 310 that defines a web path through the system. The carrier web 310 moves through the system in a downstream direction indicated by the rotation arrows on the various rolls. After being unwound or otherwise provided from a supply (e.g., the carrier web 310 may be manufactured in-line with the system depicted in FIG. 5), the carrier web 310 is directed into a transfer nip formed between a forming tool 360 and backup roll 361.

Although the composite web may preferably be manufactured formed using a forming tool in the form of a roll in the illustrated embodiments, it should be understood that the forming tools of the present invention may alternatively be provided in forms other than rolls, e.g., endless belts, etc. Furthermore, the forming tool (roll or otherwise) may be manufactured by any suitable technique, e.g., a machining, etching, helically-wound rolls (such as in, e.g., U.S. Pat. No. 6,190,594 B1 entitled TOOLING FOR ARTICLES WITH STRUCTURED SURFACES), stacked plate technology, etc.

Also, although not depicted, the major surface 312 of the carrier web 310 preferably includes an adhesive located thereon such that the adhesive faces the forming tool 360. The adhesive may be provided in any suitable form, e.g., a continuous layer or in discrete areas. In some systems, the adhesive may be applied to the surface 312 of the carrier web 310 in a process that is in-line with the forming and transfer system depicted in FIG. 5. Alternatively, the structured web being formed on the forming roll 360 may be adhesively coated before the structured web contacts the surface 312 of the carrier web 310. In another variation, the adhesive could potentially be provided as a separate distinct web directed into the nip formed by forming roll 360 and backup roll 361.

The process of providing structured web including structures 322 and connecting skin layer 324 for adhesive transfer to the carrier web 310 includes delivering a supply of a molten polymeric composition 370 to the exterior surface 362 of forming roll 360 that includes a plurality of depressions formed in its exterior surface 362. The molten polymeric composition 370 may preferably be supplied to the exterior surface 362 of the forming roll 360 by any suitable delivery apparatus. In the depicted system, the molten polymeric composition is delivered by an extruder 372. The molten polymeric composition is wiped or removed from the exterior surface 362 of the forming tool by a doctor blade 374 acting against the exterior surface 362 such that a structured web is formed that includes structures 322 interconnected to each other by a skin layer 324 extending over the outer surface of the forming roll 360.

The doctor blade 374 may be heated to a temperature that is at least as high as the melt processing temperature of the polymeric composition 372. It may be preferred that the temperature of the doctor blade be generally equivalent to the temperature of the molten polymeric composition 370 as extruded by the extruder 372 (or even higher).

The extruder 372 in the depicted system may extrude the molten polymeric composition 370 such that it is directed into the interface of the doctor blade 374 and the exterior surface 362 of the forming tool 360. In some instances, the molten polymeric composition 372 may flow down the doctor blade 374 to the interface between the blade 374 and the forming tool 360.

The forming tool 360 preferably includes depressions 364 formed in its exterior surface 362. The depressions 364 in the exterior surface 362 of the forming tool 360 are preferably filled with a portion of the molten polymeric composition 370 deposited on the exterior surface 362 of the forming tool 360. Filling of the depressions 364 by the molten polymeric composition 370 may be enhanced by the wiping action of the doctor blade 374 on the exterior surface 362 of the forming tool 360.

The flow rate of the molten polymeric composition 370 may preferably be controlled such that the volume of the molten polymeric composition may preferably be generally equivalent to the volume of the depressions 364 passing the doctor blade 374. That relationship may be advantageous because it may prevent or reduce the accumulation of thermoplastic composition behind the doctor blade 374 as the structures 322 and skin layer 324 of the structured web are formed on the forming roll 360. Accumulation of the thermoplastic composition behind the doctor blade 374 may be detrimental because of the lower forming tool temperature, which can cause the viscosity of the thermoplastic composition to increase such that the depressions cannot be filled properly and/or the skin layer becomes thicker than desired.

FIG. 6 is an enlarged partial cross-sectional view depicting one potentially suitable relationship between the doctor blade 374 and exterior surface 362 with depressions 364 in the forming tool 360. The exterior surface 362 of the forming tool 360 preferably moves past the doctor blade 374 in the direction shown by the arrow. The molten polymeric composition 370 in the depicted embodiment is incident on the upper surface of the doctor blade 374 and flows down the doctor blade 374 towards the interface between the doctor blade 374 and the exterior surface 362 of the forming tool 360. Alternatively, the molten polymeric composition flow could be adjusted such that it flows directly into the interface between the doctor blade 374 and the exterior surface 362 of the forming tool 360.

As the depressions 364 in the exterior surface 362 of the forming tool 360 pass underneath the doctor blade 374, they are preferably filled with the molten polymeric composition 370 as seen in FIG. 6. Although not seen in FIG. 6 because it is relatively thin compared to the other components depicted in FIG. 6, the polymeric composition 370 also preferably forms a skin layer on the exterior surface 362 of the forming roll 360.

In the depicted embodiment, the flow of molten polymeric composition 370 is preferably adjusted such that it is generally equivalent to the volume of the depressions 364 passing underneath the doctor blade 374 and the amount of material needed to form a skin layer extending between the depressions 364. The result is that preferably a limited amount or none of the polymeric composition accumulates at the interface of the forming tool 360 and the doctor blade 374.

Achieving that result may involve controlling the temperature of the forming tool 360 along with one or more of the following: doctor blade temperature, molten polymeric composition temperature, forming tool speed (relative to the doctor blade), flow rate of the molten polymeric composition, the pressure or force exerted on the forming tool 360 by the doctor blade 374, etc.

As discussed herein, the present invention preferably involves adhesive-assisted removal of the structured web from the forming tool and adhesive attachment of the structured web to the major surface of a carrier web. Referring again to FIG. 5, the methods of the present invention may preferably involve adhesive-assisted transfer of the structured web to the surface 312 of a carrier web 310.

In contrast to methods in which the polymeric composition (or portions thereof) within depressions on a forming tool is maintained at or near it melt processing temperature to, e.g., facilitate infiltration of a porous carrier web and/or encapsulation of fibers within the polymeric composition, the methods of the present invention preferably result in solidification of the polymeric composition while the polymeric composition is located on the forming tool such that when the structured web is, e.g., contacted with an adhesive on a carrier web, the structured web formed by the polymeric composition is removed from the forming tool and adhesively attached to the carrier web.

By solidifying the polymeric composition within the depressions and on the surface of the forming tool before the structured web is removed from the forming tool and adhered to the carrier web, infiltration of a porous carrier web and/or encapsulation of fibers on the carrier web may preferably be prevented. To adequately solidify the polymeric composition, it may be preferred that the forming tools be held at temperatures that are significantly lower than the melt processing temperature of the polymeric composition. For example, it may be preferred that the temperature of the exterior surface of the forming tool be held at a temperature of about 20 degrees Celsius or more below the melt processing temperature of the polymeric composition before the molten polymeric composition contacts the outer surface of the forming tool.

Removal of the structured web from the forming tool and attachment of the structured web to the carrier web preferably occur simultaneously such that the structures of the structured web are either located within the depressions or attached to the carrier web (i.e., the structured web is preferably not removed from the forming tool before it is adhesively attached to the carrier web). In some instances, however, adhesive attachment of the structured web to the carrier web may be enhanced by additional processing after the initial removal and adhesive attachment. For example, the composite web including carrier web with structured web adhesively attached thereto may be subjected to heat, pressure, etc. after the initial removal and attachment to strengthen the adhesive attachment of the structured web to the carrier web.

Because the polymeric composition is solidified while in the depressions and on the surface of the forming tool, the structures of the structured web preferably have a selected shape that is defined by the depressions in the forming tool. The structures of the structured web preferably take the shape of the depressions in the forming tool, that is, the structures are impressions of the depressions. Further, the selected shape of the structures as formed in the depressions is preferably not permanently distorted as the structures are removed from the depressions during the removal and attachment of the structured web to the carrier web. Such control over the shape of the structures of the structured web may provide improved control over the mechanical properties associated with those structures (e.g., elasticity, strength, etc.).

In addition to control over the selected shape of the structures, the present invention also provides the structures in a selected arrangement within the structured web. That selected arrangement of the structures of the structured web is preferably retained in the composite web because of the direct adhesive removal and attachment of the structured web to the carrier web from the forming tool. As discussed herein, removal and attachment of the structured web is preferably performed when the structured web is in a relaxed state. When in such a relaxed state, the selected arrangement of the structures in the structured web is preferably retained during the transfer process. In the preferred methods and composite webs, the structures of the structured web are either located within the depressions on the forming tool or adhesively attached to the carrier web a part of the structured web.

Although the system and method depicted in FIG. 5 produces composite webs with a structured web attached to only one major surface of the carrier web, the present invention may be used to manufacture composite webs that include structured webs on both major surfaces of the carrier web. One example of such a method may include forming and attaching structured webs to one surface of each of two separate carrier webs. The major surfaces of the two carrier webs that do not include structured webs attached thereto may then be attached to each other (e.g., laminated) to form a unitary carrier web with structured webs attached to both major surfaces. Alternatively, a single carrier web may be directed into a nip formed by two forming tools, with each of the forming tools attaching a structured web to both major surfaces of the carrier web. In another alternative, structured webs could be serially attached to opposite major surfaces of a single carrier web, with a first structured web being attached to the first major surface of the carrier web followed by attachment of a second structured web to the second major surface of the carrier web.

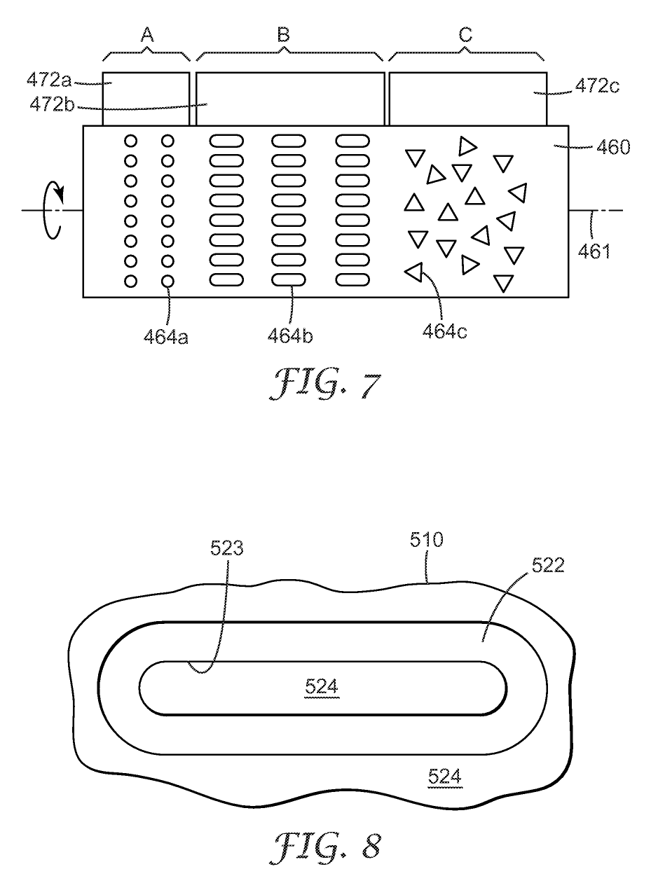

Although FIG. 5 depicts the application of only one molten polymeric composition to the forming roll, two or more different polymeric compositions may be applied to the exterior surface of a forming tool used in connection with the present invention such that a single structured web may be formed from two or more different polymeric compositions. FIG. 7 depicts a portion of one system in which three molten polymeric compositions (in zones A, B, & C) are delivered to different portions of the surface of a forming tool 460 (in the form of a roll that rotates about an axis 461). If multiple extruders 472a, 472b and 472c are used, the different polymeric compositions may be delivered in a manner such that molten polymeric compositions in the different zones do not mix during processing. Alternative techniques may be used to deliver molten polymeric compositions in different zones, such as zoned feedblocks, etc.

The forming tool 460 may also include different sets of depressions 464a, 464b, and 464c over which the different molten thermoplastic compositions may be applied. The depressions in the different zones on forming tool 460 are differently shaped, have different sizes, and have different spacing. For example, the depressions in zone C are arranged in an irregular, non-repeating pattern while the depressions in zones A & B are arranged in regular, repeating patterns. Many other variations in shape, spacing, and arrangement of the depressions are possible.

Although the structures 22 of the structured web 20 depicted in FIG. 2 cover all of the surface area of the underlying carrier web 10 located within the outer perimeters of the structures 22, the structures in a structured web of the present invention may alternatively include one or more voids in which a portion of the skin layer extends over across void formed within a surrounding polymer structure. The resulting construction may, for example, be used to reinforce the carrier web in the area of, e.g., a buttonhole, slot, perforation, or other opening formed in the carrier web. Other uses for similar structures may also be envisioned, e.g., to improve breathability of the composite web, etc.

One example of such a structure 522 on the major surface of carrier web 510 is depicted in FIG. 8. The structure 522 is in the form of a ring-shaped article that includes a void having an inner perimeter 523 across which a portion of the skin layer 524 extends. That portion of the skin layer 524 extending across the inner perimeter 523 formed within the structure 522 is surrounded by the structure 522. Although the depicted ring-shaped structure 522 and its void (as defined by inner perimeter 523) both have elongated oval-like shapes, structures in the structured webs of the present invention may be formed in any desired shape, e.g., circular, square, triangular, irregular shapes, etc.

Further, the shapes of the voids in such structures may correspond to the overall shape of the outer perimeters of the structures (as with the void in the structure 522) or they may be different. For example, the structures may have an outer perimeter in one shape (e.g., circular, etc.) while the void within the structure has a different outer shape (e.g., square, etc.). In addition, although the structure 522 includes only one void located therein, the structures provided in connection with the present invention may include more than one void formed therein. For example, a single structure of the present invention may include two or more separate and distinct voids.

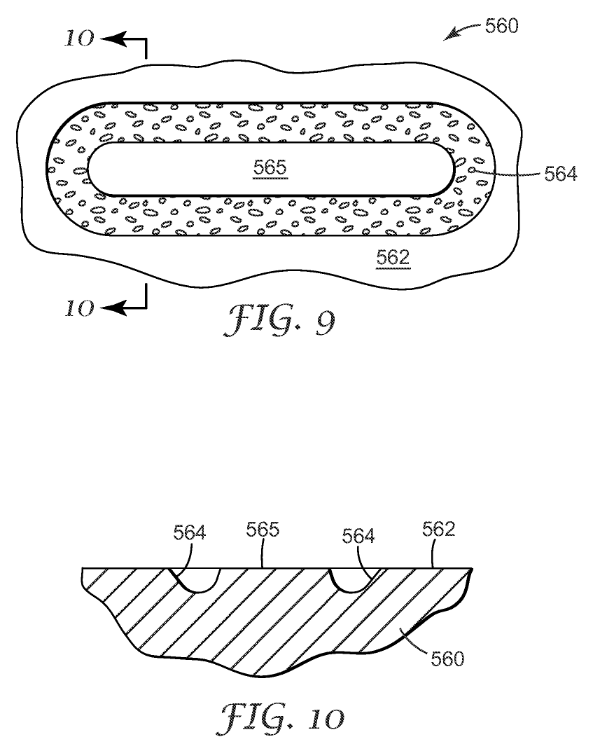

FIGS. 9 & 10 depict one example of a depression 564 in the exterior surface 562 of a forming tool 560 (only a portion of which is depicted in FIGS. 9 & 10). The depression 564 may used to form a structure 522 as depicted in FIG. 8. The ring-shaped depression 564 extends into the surface 562 of a forming tool in the form of an elongated trough with an island 565 located in the ring formed by depression 564.

The island 565 formed in the center of depression 564 may preferably be the same height as the exterior surface 562 of the forming tool that surrounds the depression 564. Although the depression 564 is depicted with only a single island 565 formed therein, depressions used in connection with the methods of the present invention may include two or more islands located within each depression if so desired (to form structures with two or more voids as discussed herein). Furthermore, the shape of the island and surrounding depression may also vary, e.g., a depression that has a circular outermost perimeter may be paired with an island having a different shape. In another variation, the island may not be centered within the depression as depicted in FIGS. 9 & 10.

Another variation depicted in FIG. 9 is the variation in depth of the depression 564 relative to the surface 562 of the forming tool 560, with the depression 564 being deepest proximate the island 565 and rising to a shallower depth at the outermost perimeter of the depression 564. Such a construction may provide a structure in a structured web with more flexible edges due to more gradual thinning at the outer perimeter of the resulting structure (where the structure meets the surrounding skin layer).

Suitable polymeric compositions for use in connection with the present invention are those that are melt processable such that they will flow sufficiently to at least partially fill depressions when deposited on the exterior surface of a forming tool and acted on by a doctor blade, yet not significantly degrade during a melt process. A wide variety of polymeric compositions may have suitable melt and flow characteristics for use in the process of the present invention depending on the geometry of the depressions and the processing conditions. It may further be preferred that the melt processable materials and conditions of processing are selected such that any viscoelastic recovery properties of the polymeric compositions do not cause them to significantly withdraw from the depressions during, e.g., wiping of the molten polymeric composition on the surface of the forming tool as described herein.

In the methods of the present invention, the exterior surface of the forming tool used to form and transfer the structured web to the carrier web is maintained at a temperature that is below the melt processing temperature of the polymeric composition. The “melt processing temperature” of the polymeric compositions of the present invention is the lowest temperature at which the polymeric composition is capable of flowing or entering into depressions in a forming tool (as described herein) within a period of five seconds or less. In some instances, the melt processing temperature may be at or slightly above the glass transition temperature for an amorphous polymeric composition or at or slightly above the melting temperature for a crystalline or semicrystalline polymeric composition. If the polymeric composition includes one or more amorphous polymers blended with either or both of one or more crystalline and one or more semicrystalline polymers, then the melt processing temperature is the higher of the highest glass transition temperature of the amorphous polymers or the highest melting temperature of the crystalline and semicrystalline polymers. In addition, it may be preferred that the temperature of the exterior surface of the forming tool be at least 20 degrees Celsius or more below the melt processing temperature of the polymeric composition deposited on the forming tool.

It may be preferred that the polymeric compositions used in connection with the present invention be thermoplastic polymeric compositions. Some examples of potentially suitable thermoplastic polymeric compositions may include, but are not limited to, polyurethanes, polyolefins (e.g., polypropylenes, polyethylenes, etc.), polystyrenes, polycarbonates, polyesters, polymethacrylates, ethylene vinyl acetate copolymers, ethylene vinyl alcohol copolymers, polyvinylchlorides, acrylate modified ethylene vinyl acetate polymers, ethylene acrylic acid copolymers, nylons, fluorocarbons, etc. Suitable thermoplastic polymers will generally have a melt flow index of 5-200 grams/10 minutes measured at the appropriate conditions for the polymer as specified in ASTM D 1238. Furthermore, the thermoplastic composition may be, e.g., a thermoplastic hot melt adhesive.

The polymeric compositions of the present invention may include either or both of nonelastomeric or elastomeric polymers. A nonelastomeric polymer is a polymer which does not exhibit elastomeric properties at ambient conditions (e.g., room temperature and pressure) when formed into a structure in a structured web. As used in connection with the present invention, “nonelastomeric” means that a structure in a structured web formed of the nonelastomeric material will not substantially resume its original shape after being stretched and relaxed. Further, the structures in a structured web formed of nonelastomeric polymers may preferably sustain permanent set following deformation and relaxation, which permanent set is preferably at least about 20 percent or more, and more preferably at least about 30 percent or more of the original length at moderate elongation, e.g., about 50% (for those materials that can even be stretched up to 50% without fracture or other failure).

An elastomeric (or elastic) polymer is a polymer that exhibits elastomeric properties at ambient conditions (e.g., room temperature and pressure). As used in connection with the present invention, “elastomeric” means that a structure in a structured web formed of the elastomeric material will substantially resume its original shape after being stretched and relaxed. Further, the structures in a structured web formed of elastomeric polymers may preferably sustain only small permanent set following deformation and relaxation, with the permanent set preferably being no greater than about 30 percent and more preferably no greater than about 20 percent of the original length at moderate elongation, e.g., about 50%.

The elastomeric polymeric compositions used in connection with the present invention can be both pure elastomers and blends with an elastomeric phase or content that will still exhibit substantial elastomeric properties at room temperature. U.S. Pat. No. 5,501,679 (Krueger et al.) provides some further discussion regarding elastomeric materials that may be considered for use in connection with the present invention.

The elastic polymeric compositions used in connection with the present invention can include one or more polymers. For example, the polymer composition could be a blend with an elastomeric phase such that the polymer exhibits elastomeric properties at room temperature. Suitable elastic polymeric compositions may include block copolymers such as conventional A-B or A-B-A block copolymers (e.g., styrene-isoprene-styrene, styrene-butadiene-styrene, styrene-ethylene-butylene-styrene block copolymers), elastomeric polyurethanes, olefinic elastomers, particularly elastomeric ethylene copolymers (e.g., ethylene vinyl acetates, ethylene/octene copolymer elastomers, ethylene/propylene/diene terpolymer elastomers), as well as mixtures of these with each other, with other elastic thermoplastic polymers, or with nonelastic polymers.

The polymeric compositions used in connection with the present invention can also be combined with various additives for desired effect. These include, for example, fillers, viscosity reducing agents, plasticizers, tackifiers, colorants (e.g., dyes or pigments), antioxidants, antistatic agents, bonding aids, antiblocking agents, slip agents, stabilizers (e.g., thermal and ultraviolet), foaming agents, microspheres, glass bubbles, reinforcing fibers (e.g., microfibers), internal release agents, thermally conductive particles, electrically conductive particles, and the like. The amounts of such materials that can be useful in the polymeric compositions can be readily determined by those skilled in the art of processing and using such materials.

The adhesives used to adhesively attach structured webs to the carrier webs in composite webs of the present invention may be of any suitable composition, e.g., curable, pressure sensitive, heat activated, hot melt, etc. If the adhesive is something other than a pressure sensitive adhesive (e.g., curable, heat activated, hot melt, etc.), it preferably exhibits sufficient tackiness to remove the structured web from the forming tool under the transfer conditions. As discussed herein, adhesive attachment of the structured web to the carrier web may be further enhanced after the removal (e.g. downstream of the transfer point).

It may be preferred to use adhesives that exhibit pressure sensitive properties. One well known technique for identifying pressure sensitive adhesives is the Dahlquist criterion. This criterion defines a pressure sensitive adhesive as an adhesive having a 1 second creep compliance of greater than 1×10⁻⁶ cm²/dyne as described in Handbook of Pressure Sensitive Adhesive Technology, Donatas Satas (Ed.), 2^{nd} Edition, p. 172, Van Nostrand Reinhold, New York, N.Y., 1989. Alternatively, since modulus is, to a first approximation, the inverse of creep compliance, pressure sensitive adhesives may be defined as adhesives having a Young's modulus of less than 1×10⁶ dynes/cm². Another well known techniques for identifying a pressure sensitive adhesive is that it is aggressively and permanently tacky at room temperature and firmly adheres to a variety of dissimilar surfaces upon mere contact without the need of more than finger or hand pressure, and which may be removed from smooth surfaces without leaving a residue as described in Test Methods for Pressure Sensitive Adhesive Tapes, Pressure Sensitive Tape Council, (1996). Another suitable definition of a suitable pressure sensitive adhesive is that it preferably has a room temperature storage modulus within the area defined by the following points as plotted on a graph of modulus versus frequency at 25° C.: a range of moduli from approximately 2×10⁵ to 4×10⁵ dynes/cm² at a frequency of approximately 0.1 radian/second (0.017 Hz), and a range of moduli from approximately 2×10⁶ to 8×10⁶ dynes/cm² at a frequency of approximately 100 radians/second (17 Hz) (for example see FIG. 8-16 on p. 173 of Handbook of Pressure Sensitive Adhesive Technology, Donatas Satas (Ed.), 2^{nd} Edition, Van Nostrand Rheinhold, New York, 1989). Any of these methods of identifying a pressure sensitive adhesive may be used to identify potentially suitable pressure sensitive adhesives for use in connection with the present invention.

The type and construction of the material or materials in the carrier web (and/or coverweb, if any) should be considered when selecting an appropriate carrier web to adhesively remove the structured web from the forming tool. For example, the carrier web should have sufficient internal strength such that it does not separate, delaminate, etc. due to forces generated during the adhesive removal of the structured web from the forming tool.

Although the carrier webs depicted in the various cross-sectional views of the composite webs manufactured according to the methods of the present invention are illustrated as single layer structures, it should be understood that the carrier webs may be of single or multi-layer construction. If a multi-layer construction is used, it will be understood that the various layers may have the same or different properties, constructions, etc. Some of these variations may be as described in, for example, pending U.S. patent application Ser. No. 09/257,447, entitled WEB HAVING DISCRETE STEM REGIONS, filed on Feb. 25, 1999 (published as International Publication No. WO 00/50229).

Examples of some potentially suitable carrier webs may include, e.g., woven material, nonwoven material, knit material, netting, scrim, foam, paper, film, or any other continuous media that can be fed through a nip point. The carrier webs may have a wide variety of properties, such as extensibility, elasticity, flexibility, conformability, breathability, porosity, stiffness, etc. Further, the carrier webs may include pleats, corrugations, microcreping, or other deformations from a flat planar sheet configuration.

In some instances, the carrier webs may exhibit some level of extensibility and also, in some instances, elasticity. Extensible webs that may be preferred may have an initial yield tensile force of at least about 50 gm/cm, preferably at least about 100 gm/cm. Further, the extensible webs may preferably be extensible nonwoven webs.

Suitable processes for making a nonwoven web that may be used in connection with the present invention may include, but are not limited to, airlaying, spunbond, spunlace, bonded melt blown webs and bonded carded web formation processes. Spunbond nonwoven webs are made by extruding a molten thermoplastic, as filaments from a series of fine die orifices in a spinneret. The diameter of the extruded filaments is rapidly reduced under tension by, for example, by non-eductive or eductive fluid-drawing or other known spunbond mechanisms, such as described in U.S. Pat. Nos. 4,340,563 (Appel et al.); 3,692,618 (Dorschner et al.); 3,338,992 and 3,341,394 (Kinney); 3,276,944 (Levy); 3,502,538 (Peterson); 3,502,763 (Hartman) and 3,542,615 (Dobo et al.). The spunbond web may preferably be bonded (point or continuous bonding).

The nonwoven carrier webs may also be made from bonded carded webs. Carded webs are made from separated staple fibers, which fibers are sent through a combing or carding unit which separates and aligns the staple fibers in the machine direction so as to form a generally machine direction-oriented fibrous nonwoven web. However, randomizers can be used to reduce this machine direction orientation. Once the carded web has been formed, it is then bonded by one or more of several bonding methods to give it suitable tensile properties. One bonding method is powder bonding wherein a powdered adhesive is distributed through the web and then activated, usually by heating the web and adhesive with hot air. Another bonding method is pattern bonding wherein heated calender rolls or ultrasonic bonding equipment are used to bond the fibers together, usually in a localized bond pattern though the web can be bonded across its entire surface if so desired. Generally, the more the fibers of a web are bonded together, the greater the nonwoven web tensile properties.

Airlaying is another process by which fibrous nonwoven webs useful in the present invention can be made. In the airlaying process, bundles of small fibers usually having lengths ranging between 6 to 19 millimeters are separated and entrained in an air supply and then deposited onto a forming screen, often with the assistance of a vacuum supply. The randomly deposited fibers are then bonded to one another using, for example, hot air or a spray adhesive.

Meltblown nonwoven webs may be formed by extrusion of thermoplastic polymers from multiple die orifices, which polymer melt streams are immediately attenuated by hot high velocity air or steam along two faces of the die immediately at the location where the polymer exits from the die orifices. The resulting fibers are entangled into a coherent web in the resulting turbulent airstream prior to collection on a collecting surface. Generally, to provide sufficient integrity and strength for the present invention, meltblown webs must be further bonded such as by through air bonding, heat or ultrasonic bonding as described above.

In some embodiments, it may be preferred to impart some extension into a carrier web and/or a composite web. Extension or permanent elongation of the carrier web may be particularly useful when the carrier web is a nonwoven web. Examples of some potentially suitable processes may be discussed in, e.g., U.S. Patent Application Publication No. US2005/0214461. For example, FIG. 3 of that reference depicts a process in which portions of an article are incrementally stretched such that the article is permanently elongated. Due to the structural changes that occur in response to the stretching, the article has a reduced resistance to stretch and elastomeric structures attached to the article may preferably be able to stretch to the extent provided by the permanent elongation of the carrier web.

Extension or elongation of the carrier web may be performed before attaching the structured web or after attaching the structured web. If the carrier web is stretched or elongated before attaching the carrier web, such stretching or elongation may be performed before or after applying the adhesive to the carrier web that will be used to attach the structured web. Stretching or elongation of the carrier web may provide beneficial properties to the resulting composite web. The stretching or elongation may be in the machine or down-web direction and/or in the cross-web direction (which may cause necking as discussed in, e.g., U.S. Pat. Nos. 4,965,122 & 4,981,747 (both to Morman)). Processes that cause necking in the carrier web may potentially be useful to create cross-web extensibility in the carrier web and, thus elasticity in the composite web.

A process sometimes referred to as “ring-rolling” may be a desirable incremental stretching operation of the present invention. In the ring rolling process, corrugated interengaging rolls are used to permanently elongate an article to reduce its resistance to stretch. The resulting composite has a greater degree of stretchability in the portions that have been subjected to the ring rolling process. Thus, this secondary operation may provide additional flexibility in achieving stretch properties in localized portions of the article.

Methods for imparting stretchability to an extensible or otherwise substantially inelastic material by using corrugated interengaging rolls that incrementally stretch in the machine or cross-machine direction and permanently deform the material that may be suitable for use in connection with the present invention are disclosed in U.S. Pat. Nos. 4,116,892; 4,834,741; 5,143,679; 5,156,793; 5,167,897; 5,422,172; and 5,518,801. In some embodiments, an article may be fed into the corrugated interengaging rolls at an angle with respect to the machine direction of this secondary operation. Alternatively, the secondary operation may employ a pair of interengaging grooved plates applied to the intermediate structure under pressure to achieve incremental stretching of the intermediate structure in localized portions.

Extensibility may also be imparted to the carrier web via necking as described in U.S. Pat. Nos. 5,226,992 and 5,910,224 (both assigned to Kimberly-Clark Worldwide, Inc.). Another method of imparting extensibility is by consolidation as described in U.S. Pat. Nos. 5,914,084 and 6,114,263 (both assigned to The Procter & Gamble Company).

It may be desirable that an extensible carrier web does not exhibit resistance to stretch when the composite web is subjected to a typical strain under the in-use condition. The in-use strains experienced by the composite web may be due to the stretching when, e.g., the composite web is used in a garment or other article that is applied to or removed from a wearer and when the article is being worn. The extensible carrier web in such a composite web may preferably be pre-strained to impart the desired stretchability to the composite web. Typically, when the extensible carrier web is pre-strained to about 1.5 times of the maximum in-use strain (typically less than about 250% strain), the extensible carrier web becomes permanently elongated such that it does not exhibit resistance to stretch within the range of in-use strain and the elastic properties of the composite web are substantially the same as the sum of the elastic properties of the structured web and the carrier web (and other components) used in the composite web.

A carrier web and/or composite web can also be made extensible by skip slitting as is disclosed in, e.g., International Publication No. WO 96/10481 (Abuto et al.). If an elastic, extensible web is desired, the slits are discontinuous and are generally cut on the web prior to the web being attached to any elastic component, e.g., an elastic structured web. It may also be possible to create slits in the nonelastic carrier web after the elastic structured web is attached to the nonelastic carrier web. At least a portion of the slits in the nonelastic carrier web may preferably be generally perpendicular (or have a substantially perpendicular vector) to the intended direction of extensibility or elasticity (the at least first direction) of the elastic composite web. By generally perpendicular it is meant that the angle between the longitudinal axis of the chosen slit or slits and the direction of extensibility is between 60 and 120 degrees. A sufficient number of the described slits are generally perpendicular such that the overall composite web is elastic. The provision of slits in two directions is advantageous when the elastic composite web is intended to exhibit elasticity in at least two different directions.

Having thus described some of the basic characteristics of composite webs and methods and systems of manufacturing them according to the present invention, one exemplary application of the present invention will now be described. Some composite webs of the present invention may be used in articles to provide elasticity, i.e., the ability to at least partially recover their original shape after moderate elongation, may be desired for a number of reasons. For example, elasticity may be useful in connection with fastening systems for items such as garments (e.g., diapers, training pants, gowns, etc.). Elasticity in garments can provide what may be referred to as dynamic fit, i.e., the ability to stretch and recover in response to movement by the wearer.

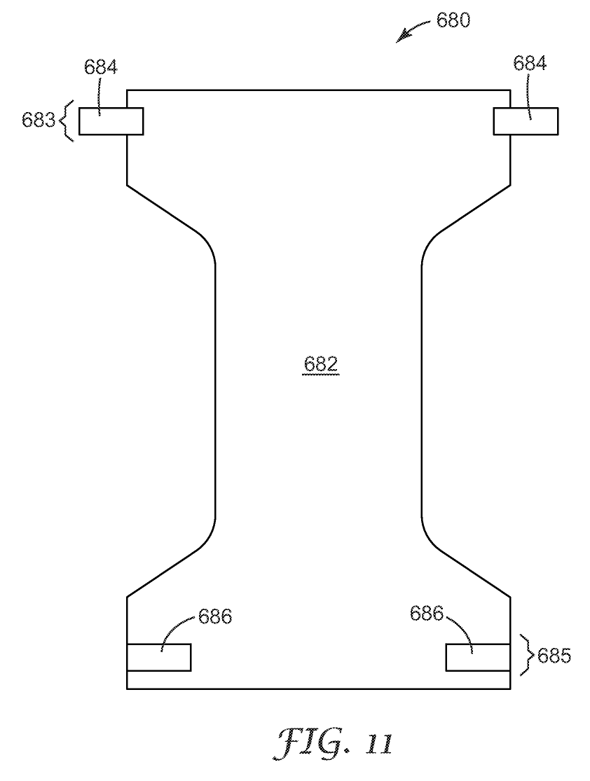

FIG. 11 depicts one example of a disposable diaper 680 that may include one or more components manufactured of composite webs according to the present invention. The diaper 680 includes a body 682 that may be manufactured of various materials useful in connection with diapers. Some exemplary diaper constructions may be described in, e.g., U.S. Pat. Nos. 5,399,219 (Roessler et al.) and 5,685,873 (Bruemmer et al.). Although the exemplary article that may incorporate composite webs of the present invention described herein is a diaper, the composite webs of the present invention could also be employed with other articles, such as caps, gowns, shoe covers, feminine care articles, incontinence garments and the like.

The diaper 680 may preferably include fastening tabs 684 that extend laterally from the body 682 and are connected to opposing lateral ends of at least one waistband portion 683 for securing the waistband sections of the article about a wearer during the use of the article. The fastening tabs 684 may preferably incorporate one or more composite webs according to the principles of the present invention

The diaper 680 may also include fastening tab receiving areas 686 that are located in a waistband portion 685 at the opposite end of the diaper 680. Fastening tabs 684 may be attached to the fastening tab receiving areas 686 to retain the diaper on a wearer. Although two receiving areas are depicted in FIG. 11, it will be understood that in some instances a single larger receiving area may be provided that extends substantially across the diaper in the area of waistband 685.

Fastening tab receiving area 686 can have any suitable construction to retain the fastening tab 684. For example, if the fastening tab 684 includes hooks formed thereon, the receiving area 686 may be constructed of, e.g., loop material that cooperates with the hooks to retain the fastening tab 684 on the receiving area 686.

### Example

The following non-limiting example is provided only to illustrate one method of manufacturing a composite web in accordance with some principles of the present invention.

A composite web was produced using a system similar to that shown in FIG. 5. A 75 mm diameter single screw extruder was used to deliver a molten polymer consisting of a blend of 70% by weight styrene-ethylenebutylene-styrene block copolymer (KRATON G1657), 30% by weight metallocene-catalyzed polyethylene (Engage 8452), and 2 parts per hundred TiO2 masterbatch (Clariant), at a melt temperature of approximately 235 degrees C. to a neck tube.

The neck tube was connected to a die that delivered the molten polymer to the exterior surface of a steel forming roll having a circumference of approximately 185 cm. The die was designed to deliver the molten polymer in two separate stripes so as to deposit the molten polymer onto the portions of the forming roll bearing depressions, as described below. At the base of the die was a doctor block.

The exterior surface of the forming roll had been machined using a chemical etching process to have depressions formed therein in the shape of arrayed rectangles. The rectangles had a width of 1.5 mm in the cross-roll direction and a length of 2.5 mm in the machine (downweb) direction. The rectangles were spaced on a square array with a center-to-center spacing of 4.2 mm in both the cross-roll and machine directions. Two such arrays were present on the roll, arranged in stripes in the machine direction, with a flat roll surface (bearing no depressions) in between the two stripes. The forming roll had been plasma coated with a release coating after the depressions were machined. During operation, the temperature of the roll was controlled using water circulated through the interior of the roll, the water being held at a nominal temperature of 40 degrees C. as delivered to the roll.

The die and doctor block were positioned such that a film of molten polymer was formed on the surface of the forming roll. The rotation of the forming roll caused the doctor block to wipe the molten polymer into the depressions while forming a thin skin layer of polymer on the outer surface of the forming roll. The excess molten polymer formed a small rolling bank during this process.

After the wiping action of the doctor block, the forming roll continued to rotate until the structured webs on the outer surface of the forming roll were forced into contact with a nonwoven carrier web, against a conformable backup roll wrapped with TESA release tape.

The nonwoven carrier web was a high extension carded nonwoven with a basic weight of 27 grams per square meter basis weight (Product C0075 Style 3320, BBA Nonwovens). The side of the nonwoven facing the structured web was spray-coated with an adhesive, at a temperature of 177 degrees C. in a Summit spiral pattern (Nordson), at a basis weight of 4.5 grams per square meter.

A pressure sensitive adhesive bond was obtained between the structured webs and the nonwoven carrier web, such that when the carrier web/structured web laminate was directed away from the forming roll, the structured web released cleanly from the surface of the forming roll.

Although not depicted in FIG. 5, the carrier web/structured web laminate was then directed through a second nip between two rubber rolls, at which point a second nonwoven coverweb bearing adhesive (as described above with respect to the carrier web) was laminated to the exposed surface of the structured web so as to form a trilaminate composite web including two outer layers of nonwoven (the carrier web and a coverweb) and two inner structured webs bearing the structures imparted by the forming roll, the structured webs being present in two stripes in the downweb direction.

The terms “comprises” and variations thereof do not have a limiting meaning where these terms appear in the accompanying description and claims. Moreover, “a,” “an,” “the,” “at least one,” and “one or more” are used interchangeably herein.

The exemplary embodiments described herein are illustrative of the practice of the invention. This invention may be suitably practiced in the absence of any element or item not specifically described in this document. The complete disclosures of all patents, patent applications, and publications are incorporated into this document by reference as if individually incorporated. Various modifications and alterations of this invention will become apparent to those skilled in the art without departing from the scope of this invention. It should be understood that this invention is not to be unduly limited to illustrative embodiments set forth herein.

1. An elastic composite web comprising:
an extensible carrier web;
a structured web having a first major surface adhesively attached to a first major surface of the carrier web by adhesive located between the first major surface of the carrier web and the structured web first major surface, the structured web comprising a skin layer interconnecting a plurality of structures;
wherein the structures of the plurality of structures exhibit elastic behavior;
wherein the plurality of structures are in a selected arrangement on the first major surface of the carrier;
wherein the structured web is in a relaxed state on the first major surface of the carrier web;
wherein the first major surface of the carrier web is porous; and
wherein a polymeric composition of the structured web does not infiltrate the porous surface.

2. An elastic composite web according to claim 1, wherein the plurality of structures comprise a thickness of 75 micrometers or more and the skin layer comprises a thickness of 10 micrometers or less.

3. An elastic composite web according to claim 1, wherein a ratio of structure thickness to skin layer thickness is 5:1 or more and wherein the skin layer thickness is 10 micrometers or less.

4. An elastic composite web according to claim 1, wherein the carrier web comprises a nonwoven web that is permanently elongated before the structured web is adhesively attached to the carrier web.

5. An elastic composite web according to claim 1, wherein the pattern comprises uniform spacing between all of the structures of the plurality of structures.

6. An elastic composite web according to claim 1, wherein the adhesive is a pressure sensitive adhesive.

7. A composite web comprising:
a carrier web;
a structured web having a first major surface adhesively attached to a first major surface of the carrier web by adhesive located between the first major surface of the carrier web and the structured web first major surface, the structured web comprising a skin layer interconnecting a plurality of structures;
wherein the plurality of structures comprise a thickness of 1 millimeter or less and the skin layer comprises a thickness of 50 micrometers or less;
wherein the plurality of structures are in a selected arrangement on the first major surface of the carrier;
wherein the structured web is in a relaxed state on the first major surface of the carrier web;
wherein the first major surface of the carrier web is porous; and
wherein a polymeric composition of the structured web does not infiltrate the porous surface.

8. A composite web according to claim 7, wherein a ratio of the structure thickness to the skin layer thickness is 5:1 or more and wherein the skin layer thickness is 10 micrometers or less.

9. A composite web according to claim 7, wherein the carrier web comprises a nonwoven web that is permanently elongated before the structured web is adhesively attached to the carrier web.

10. A composite web according to claim 7, wherein the adhesive is a pressure sensitive adhesive.

11. An elastic composite web comprising:
an extensible carrier web;
a structured web having a first major surface adhesively attached to a first major surface of the carrier web by adhesive located between the first major surface of the carrier web and the structured web first major surface, the structured web comprising a skin layer interconnecting a plurality of structures;
wherein the structures of the plurality of structures exhibit elastic behavior;
wherein the plurality of structures are in a selected arrangement on the first major surface of the carrier;
wherein the structured web is in a relaxed state on the first major surface of the carrier web;
wherein the first major surface of the carrier web is fibrous; and
wherein a polymeric composition of the structured web does not encapsulate fibers of the fibrous first major surface.

12. An elastic composite web according to claim 11, wherein the plurality of structures comprise a thickness of 75 micrometers or more and the skin layer comprises a thickness of 10 micrometers or less.

13. An elastic composite web according to claim 11, wherein a ratio of structure thickness to skin layer thickness is 5:1 or more and wherein the skin layer thickness is 10 micrometers or less.

14. An elastic composite web according to claim 11, wherein the carrier web comprises a nonwoven web that is permanently elongated before the structured web is adhesively attached to the carrier web.

15. An elastic composite web according to claim 11, wherein the pattern comprises uniform spacing between all of the structures of the plurality of structures.

16. An elastic composite web according to claim 11, wherein the adhesive is a pressure sensitive adhesive.
